(19) United States
(12) Patent Application Publication
(10) Pub. No.: US 2003/0206521 A1
(43) Pub. Date: Nov. 6, 2003

(54) Methods to route and re-route data in OBS/LOBS and other burst swithched networks

(76) Inventor: Chunming Qiao, Williamsville, NY (US)

Correspondence Address: Chunming Qiao, c/o John Staley, 5802 Flintshire Lano, Dallas, TX, 75252, US

(21) Appl. No.: 10/429,381

(22) Filed: May 5, 2003

Related U.S. Application Data
(60) Provisional application No. 60/380,052, filed on May 6, 2002.

(51) Int. Cl. H04L 12/56

(52) U.S. Cl. 370/230; 370/468

(57) ABSTRACT

A method consisting of the coordinated application of novel ways to format and assemble bursts, route them, make/release bandwidth reservation, and in addition, provide for failure recovery and contention resolution among priority classes of packets and bursts within Optical Burst Switched, Labeled Optical Burst Switched, Labeled Analog Burst Switched, and other bufferless, burst switched networks.

### CROSS REFERENCE TO RELATED APPLCATION

This application claims the benefit of U.S. Provisional Application No. 60/380,052, filed May 6, 2002, which is incorporated by reference herein.

### FIELD OF THE INVENTION

This invention relates to the application of unique methods for routing and re-routing data to reduce data loss rate and increase throughput, as well as to deal with congestion and faults (e.g., broken links or nodes) in Optical Burst Switched (OBS), Labeled Optical Burst Switched (LOBS), and other burst or packet switched networks.

### BACKGROUND OF THE INVENTION

Burst switched networks (wherein a burst is the concatenation of one or more packets of variable length), like packet switched networks, can be bandwidth efficient in carrying bursty traffic as they are capable of switching bandwidth within a small timescale. As a potential price paid to realize this bandwidth efficiency for bursty traffic in packet switching and burst switching networks, data loss due to contention is possible. In addition, data loss due to link or node failure is also possible, just as in circuit-switched networks.

In an optical packet or burst switched networks, data loss due to contention is more likely than in electronic networks as a plenty of buffers can be used in the latter for content resolution whereas no or only limited delays is available in the former. The amount of data loss due to a broken link or failed node can also be higher in the former where the date rate on a link is higher.

The desire to keep the data in the optical domain, and the limitations imposed by having such a transparency to bit-rate, format and protocol also make contention resolution and recovery from link/node failure difficult.

It is, therefore, an object of the current invention to resolve contention, as well as recover from a failed link/node in OBS/LOBS networks in an integrated, systematic way to reduce data loss. It is also an object of the invention to support multiple priority classes by providing differentiated Quality-of-Service (QoS) to them.

### BRIEF DESCRIPTION OF PRIOR ART

Prior arts in optical packet/burst switched networks, with or without label switching, have attempted to address the contention resolution issue at the network layer (i.e., within the optical packet/burst switched core) through space domain, i.e., deflection or hot-potato routing (whereby all but one (the lucky) contending bursts are routed to unintended output port(s)), time domain, i.e., using limited fiber delay lines or FDLs (to buffer all but one contending bursts until the intended output becomes free), and wavelength domain, i.e., through wavelength conversion so as to route all but one contending bursts to different wavelengths available at the same output port.

Recently, priority-based schemes, e.g., the one that assigns an extra offset time to high-priority bursts (so their chance of winning contention is higher than low-priority bursts), and the so-called partial burst delivery scheme based on, e.g., partial pre-emption, where the tail of a preceding burst that is causing the contention is dropped (to accommodate the entire following/contending burst), have also been suggested.

For failure recovery (and contention resolution), deflection routing at the point of failure, and re-transmission by ingress nodes, with or without a back-off interval, along an alternate path that routes around the failed link/node, have also been studied. Deflection routing of an entire contending burst or its tail or head (but not both) has also been described recently.

Under the existing framework of Generalized Multiple-protocol Label Switching (GMPLS), deflection routing along a pre-established, alternate label switched path (LSP) to route around failures and/or congestion, or using a pre-determined “looping” LSP just as a FDL to simply buy some time for the contending packet/burst, have also been proposed. In addition, methods to route LSPs to achieve load-balancing, and/or minimize the load on “critical” or potentially “bottleneck” links so as to prevent future LSPs from being blocked have been studied to some extent. Finally, an extension of GMPLS, called LOBS where control packets contain labels and follow pre-established LSPs, while the data are sent in bursts following their corresponding control packets as in OBS, has also been proposed.

### SUMMARY OF INVENTION

This invention proposes novel ways to format and assemble bursts, route them, make/release bandwidth reservation, and in addition, integrate these and other methods to achieve the objects stated above.

### BRIEF DESCRIPTION OF THE DRAWINGS

FIG. 1 depicts the existing burst assembly schemes to support QoS (top), and the proposed scheme that allow packets with different priorities to be in the same burst (bottom).

FIG. 2 depicts the enhanced control packet format to facilitate contention resolution and failure/loss recovery with pre-emption/dropping of sub-bursts using the marker information.

FIG. 3. depicts the notations and timing diagram used to describe the proposed methods

FIG. 4 depicts the flow chart for contention resolution along the active path (AP), and in particular the three proposed operations.

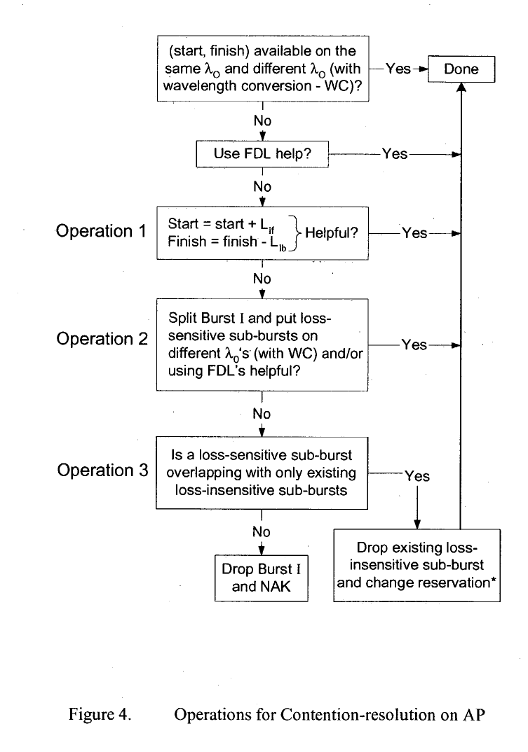

### DETAILED DESCRIPTION OF INVENTION

The following discussion assumes a LOBS network although the concepts/methods described below can also be applied to OBS or similar networks. In addition, it assumes that low-priority, loss-insensitive bursts can be simply dropped in the presence of congestion or failed links/nodes, but the proposed schemes and methods will results in low loss for loss-sensitive (and thus high-priority) bursts, and low delay for delay-sensitive bursts. For illustration purposes, we assume that there are 8 classes for packets (as specified by 3 bits in IPv6) with class 1 being the least sensitive to loss (and thus for our discussion, having the lowest priority) and class 8 being the most sensitive to loss (and thus having the highest priority).

Hybrid Burst Priority (HBP) Scheme

In a LOBS network, packets, which in general refer to protocol data units (PDUs) such as IP packets, ATM cells, SONET frames, Ethernet frames, or data from other application/transport layers, are assembled at the edge ingress node into bursts. Only the packets going to the same egress node (where some of the packets may re-enter the LOBS network in order to reach their final destination egress node in a multi-hop fashion) can be possibly assembled into the same burst.

In addition, existing QoS solutions permit only the packets belonging to the same Forward Equivalence Class (FEC) (e.g., packets having the same egress node as well as priority) to be assembled into the same burst because the packets in the same burst receive the same priority and thus treatment within the LOBS core. Of course, existing schemes also allow different bursts to be assigned different priorities (e.g., in the form of different extra offset times).

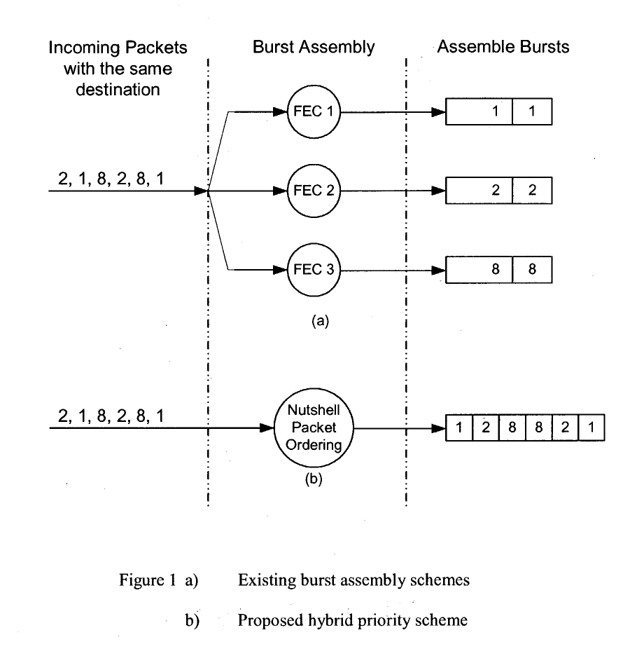

As a part of our strategies for content resolution and failure recovery, and to potentially reduce high-priority bursts' pre-transmission delay introduced by the extra offset time, and burst assembly time, as well as to improve switching efficiency, a hybrid burst priority (HBP) scheme is hereby proposed. In HBP, packets having different priorities may be assembled into the same burst (see FIG. 1).

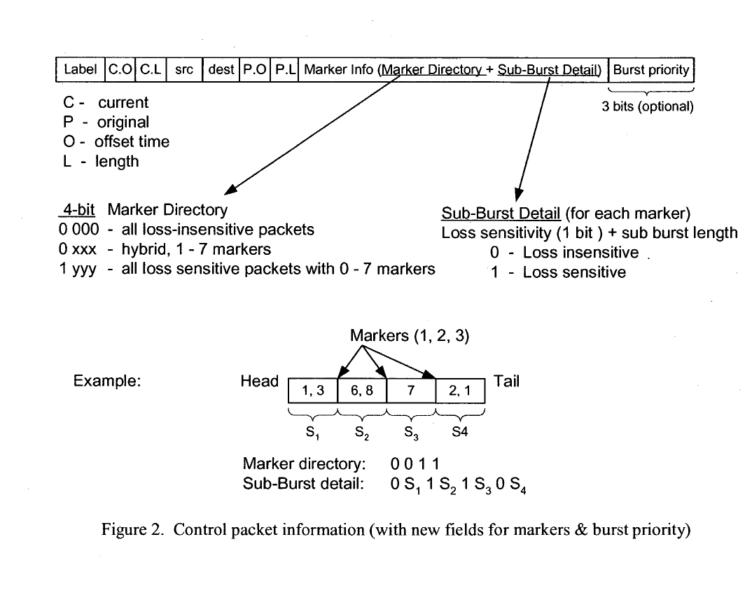

The priority of such a burst can then be calculated as the weighted average of the priorities of each byte of the burst (rounded to the nearest integer). For example, if a burst A contains 12K bytes, of which 10K bytes belong to packets of class 8, and 2K Bytes belong to packets of class 2, burst A's priority is (8×10+2×2)/12=7. Another burst B may have 10K Bytes, of which 4K Bytes belong to packets of priority 7 and the remaining 6K Bytes belong to packets of priority 6, and accordingly, burst B's priority is (4×7+6×6)/10=6.4 or 6. Using the above methods, one can determine (at least relatively) which burst has a higher priority than others, and hence provide another level of differentiation by e.g., assigning a longer offset time to a higher priority burst. An optional 3-bit field in a control packet will be used to indicate the burst priority (with a binary value of 0-7, which maps to priority 1-8) as in FIG. 2. Hereafter, we will only distinguish loss-insensitive (e.g. having low priority 1 to 4) burst or sub-bursts from loss-sensitive bursts or sub-bursts (e.g., having high priority 5 to 8).

The Nutshell Packet Ordering Scheme

The following discussion will focus on the HBP scheme, and more specifically, how the packets of different priorities are assembled or ordered in a burst. Assuming that at the time a burst is to be assembled, there are packets of classes, say 1,2, . . . ,8, which can all be put into one burst. For reasons to become clear later, we propose to put packets of class 1 at the very beginning and/or end of the burst, then packets of class 2 as close to the two ends as possible and so on (see FIG. 1 as well as FIG. 2 for examples), in order to center the higher priority packets as much as possible. An analogy is to protect the highest priority packets (as a nut) with lower priority ones (as shell) at each side.

There may be many variations of the above NutShell packet ordering scheme. For example, if there are only one class 1 packet and one class 8 packet to assemble into a burst, the bytes in the class 1 packet may or may not be distributed over the both ends, and if they are not, the entire packet may be put at the beginning of the burst, or may be at the end of the burst.

The Sub-Burst Boundary Marker

Once the packet ordering is determined, each burst will carry zero or more “markers” to indicate the boundary between packets at which the burst may be partitioned into sub-bursts (for the purpose of contention resolution and failure recovery). The information about each marker is stored in the control packet (see FIG. 2).

There can be many rules governing the number of markers a burst can/should have, and if there are one or more such markers but not as many markers as the number of packets in a burst, where to place these markers. In other words, the sub-bursts can have variable lengths, and the (minimum and maximum) length of a sub-burst can be adjusted according to network load, switching speed and other factors to maximize the performance gain.

We propose the following two requirements in partitioning a burst: (1) the packet boundaries must be preserved, and (2) there should be one marker separating a low-priority packet from a high-priority packet. Hence, a burst consisting of all high-priority packets may have zero or more markers, but the one consisting of some high-priority packets in the middle and low-priority packets at both sides will have at least two markers (See FIG. 2). Even if a burst (or sub-burst) only carries high-priority packets, it may still carry one or more markers to separate one or more packets from the rest. But a burst (or sub-bust) consisting of all low-priority packets, or all high-priority packets does not need to carry any markers for the purpose of this invention.

Control Packets and Reservation for HBP

In addition to the number of markers, each control packet will carry the information on each sub-burst. A simple scheme is to record for each sub-burst, from the head of the burst to the tail of the burst, the loss-sensitivity of the sub-burst and its length, as illustrated in FIG. 2.

After a burst is scheduled on a channel at a particular node, the location of some (not necessarily all) markers, as well as the loss-sensitivity of some (not necessarily all) sub-bursts are recorded to facilitate future scheduling operations.

Contention Resolution and Failure Recovery Strategy

For each LOBS path which may carry loss-sensitive packets under working conditions (called active path or AP for short), an alternate LOBS path, called backup path or BP for short, which is link or node disjoint with AP, will be set-up according to certain traffic engineering criteria. This BP can be used for the purpose of carrying out Double Delayed reservation (DDR) primarily for loss-sensitive sub-bursts. In addition, at each node along the BP (except the destination), a detour path will be dynamically determined based on certain routing policies for the purpose of deflecting sub-bursts carrying loss-sensitive packets.

1) Double Delayed Reservation (DDR)

With DDR, a control packet is sent along an AP, and another control packet along its corresponding BP (if any) concurrently, to perform delayed reservation on each path. For the purpose of this discussion, let the expected time to send a control packet along a given AP (which has a corresponding BP), and receive an ACK from the egress node be Tp (which may be calculated based on the formula used for time-out in TCP for example).

Also, let the length of the high-priority sub-burst be Lh<=L (the total length of the burst),

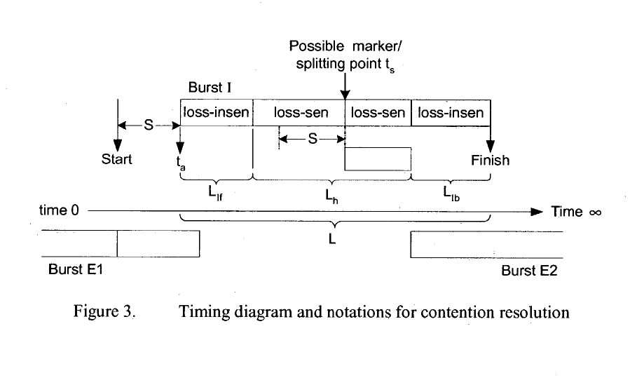

the length of the low-priority sub-burst near the head of the burst be LIf, and that near the back of the burst be Llb, where Llf+Llb=L−Llh (see FIG. 3)

The offset time used for AP can be determined using existing strategies based on the total control packet processing delay along the AP plus any extra offset time that might be assigned to the burst. However, the control packet will carry, in addition to the burst length L, information on the markers as described earlier to facilitate dropping of low-priority sub-bursts along the AP.

No deflection routing will be performed along the AP.

On the other hand, the offset time used for the corresponding BP (and carried by the control packet sent along the BP) is equal to Tp (note that Tp should be larger than the sum of the control packet processing delay along the BP). Also, unlike the case for the AP, the control packet will carry Lh (instead of L) as the burst length, and deflection routing of the control packet (and high-priority sub-burst) will be possible (subject to available offset time after a number of deflections to ensure that data does not surpass the control packet). Like the case for AP, additional information on markers is needed.

2) Full ACK/NAK Schemes for AP

For the following discussion, we assume that the time event axis goes from left to right as in FIG. 2. When a control packet arrives at a node along the AP, it tries to reserve bandwidth on a certain wavelength channel for the corresponding burst I (based on the current offset time and burst length information). Specifically, let the current time be t_c, the current offset time be t_o, and the current burst length be L. Then, the burst arrival time is t_a=t−c+t+o. Let the maximum switching time over all switches be s (e.g., several nanoseconds). To facilitate bandwidth reservation, switching fabric control, as well as offset time setting, we define the “start” time to be “t_a−s” and “finish” time to be “t_a+L” (see FIG. 3).

The case where bandwidth can be found for the period (start, finish) is trivial, and suffice it to say that if the control packet reaches the egress node after succeeding in making reservation at each and every node in this way, an ACK will be sent to the ingress node.

Further, if the above reservation is unsuccessful using any existing contention resolution techniques exploiting the wavelength domain (i.e., by scheduling the entire burst on an output wavelength that is different from the input wavelength using wavelength conversion), the time domain (using FDLs), and the combination of the two because either burst I's head (more precisely, it's the “start” time not “t_a”) would overlap with the tail of an existing burst E1 (for OL1 units), or burst I's tail would overlap with the head of an existing burst E2 (for OL2 units), or both, but burst I carries at least one high-priority sub-burst, we propose to perform the following three operations in the order specified below:

Operation (1) If OL1<=Llf and OL2<=Llb, drop the portion of the low-priority sub-bursts of burst I that are causing the overlap with E1 and E2, and after a sub-burst is dropped, the current offset time is increased by OL1, the current length is decreased by OL1+OL2, and the “start” time is increased by OL1.

Operation (2) if Operation 1 fails, entire low-priority sub-burst of Burst I will be dropped first. Given that the remaining high-priority sub-burst still overlaps with E1 and/or E2, we will try to split the high-priority sub-burst if possible (at the marker locations), and schedule those (at most two) sub-bursts that are causing the overlap with E1 and E2 on different wavelength channels (assuming wavelength converters are available). Note that after splitting a burst, a control packet needs to be created for each sub-burst (by modifying the current control packet), and for each sub-burst, we need to determine the appropriate “start” time.

Operation (3) if it is still necessary, and in particular, if each loss-sensitive sub-burst overlaps only with some existing loss-insensitive bursts or sub-bursts (E1 and/or E2) for OL units, the portion of those loss-insensitive sub-bursts (whose existing reservations are causing problems for the loss-sensitive sub-bursts of burst I), equal to at least OL (but not unnecessarily longer), are dropped. Afterwards, a special control packet (called the reservation change packet) may need to be sent to the switching fabric controllers as well as the channel bandwidth manages that previously handled affected bursts (E1 and/or E2) as to be described below starting at [0049].

If a high-priority sub-burst still cannot be accommodated at this or some downstream nodes later, an NAK reporting the loss of that specific sub-burst is sent to the ingress node.

3) Reservation Change and Partial ACK/NAK for AP

If Operation 3 is carried out, and as a result, the tail (or head) low-priority sub-burst of E1 (or E2) is preempted, control information related to E1 (or E2) may need to be modified. In the following, we will focus on the case where E1 is affected by operation 3 and note that the case for E2 is similar.

If the corresponding control packet for E1 has not left the node yet, it can be updated appropriately to reflect the changes (e.g., in the offset time, burst length, and/or marker information). In addition, the switching fabric controller will need to update its existing entry for E1 (or set up a new entry for E1, in addition to burst I). For example, assume that after a control packet is processed, the switch fabric controller sets up an entry for the corresponding burst, which may consist of a vector (in_port, in_wave, out_port, out_wave, start, finish) to indicate the input port (and fiber if each port has multiple fibers), input wavelength, output port, output wavelength (which may differ from the input wavelength if wavelength conversion is available), the time to set the switch, and the burst's departure time, respectively. Then, since E1 lost a tail of length OL1 (<=Llb), the departure time in the entry should be reduced by OL1. (Similarly, if E2 lost a head sub-burst of length OL2<=Llf, the start time in the entry should be increased by OL2).

Note that the case where the control packet for E1 has already left the node is much more complicated. This is because not only the switching fabric controller but also the bandwidth manager (which schedules bursts on each wavelength channel) need to amend their reservation information for E1. More specifically, let the current node be numbered “N”, and the values in the fields out_port, out_wave, and start in the newly created entry for burst I be v1, v2, and v3, respectively. We propose the following procedure:

Step I) We first determine the entry maintained by the switching fabric controller for E1, which will be denoted by SF(N, E1). This entry can be found by searching the fields: out_port, out_wave, finish until their values match with v1, v2 and v3+OL1, respectively. Once found, a “change-reservation” control packet, which contains Llb in its “diff-finish” field, and the values stored in the following fields of SF(N, E1): out_port, out_wave, start, finish, to be denoted by V1(=v1), V2(=v2), V3, and V4(=v3+OL), is sent to the immediate downstream node “N+1” over a control channel. The value in the field finish in SF(N, E1) is then decreased by OL, and the bandwidth manager will also update the reservation made for E1 on the channel specified by V1 and V2.

Step 2) Note that according to physical mapping of the interfaces at nodes N and N+1, there is a unique matching value of in_port at N+1 for a given value of out_port at N. So when node “N+1” receives this change-reservation control packet, it replaces V1 carried by the change-reservation control packet with the matching value of “in_port”, and then looks up for an entry maintained by the switching fabric controller whose fields in_Port and in_wave store values that match with V1 and V2, respectively, and whose start field stores a value that is no smaller than V3+p but less than V4+p, and whose finish field has a value that is no larger than V4+p, where p is the propagation delay from node N to node N+1. There are two cases:

Case I) If such an entry is found, it must have been created for E1 at node N+1, and will be called SF(N+1, E1). There are three sub-cases:

I-A) If the value in its field finish is equal to V4+p, the value can be decreased by OL Oust as the entry created at node N is updated). Similarly, the bandwidth manager will update the reservation made for E1 on the channel specified by the fields out_port and out_wave in SF(N+1, E1).

I-B) If the value in the field finish, say f, is smaller than V4+p (implying that its reservation at node N+1 has been updated by another change-reservation control packet), and is no larger than V4+p−OL, the change-reservation control packet will be dropped as no further actions need to be taken to update relevant information regarding E1 at this node or other downstream nodes.

I-C) If f mentioned in subcase I-B is larger than V4+p−OL, it will be decreased by Llb′=f−(V4+p−OL) but only after replacing the change-reservation control packet with a new change-reservation packet to be sent to the immediate downstream node of N+1 (determined by the field out ort in SN(N+1, E1). This new change-reservation control packet contains properly updated diff-finish value (which is Llb′) as well as the values of the fields out_port, out_wave, start, and finish taken from SF(N+1, E1).

Case II) If no such an entry mentioned in Case I is found, the reservation for E1 at node N+1 was either unsuccessful or has been deleted (as a recent of other updates). In this case, the change-reservation control packet will be dropped as no further actions need to be taken (as in Case I-B above).

Note that even with the above three operations, a high-priority sub-burst may still be dropped before it can reach its destination. But such a high-priority sub-burst is never deflected to a different route, which facilitates the calculation of the offset time, time-out values, in-order delivery and traffic engineering. However, when splitting of a high-priority sub-burst is done, several (but not all) loss-sensitive packets in a burst may be lost. Of course, due to possible dropping of low-priority sub-bursts, a partial ACK/NAK packet needs to be sent to the ingress node by the egress node when it receives a part of the burst, instead of a full NAK (sent by an intermediate node) or a full ACK sent by the egress node mentioned earlier.

4) Reservation Along BP

As mentioned in Section 2 (Double Delayed Reservation), a reservation packet for a burst length of Lh is sent along a node-disjoint BP with an offset time of Tp. The primary objective is to reserve the bandwidth for all the high-priority packets (whose length is Lh) contained in a burst to overcome possible reservation failures along the AP (due to for example, link or node failures).

We propose to use methods similar but not identical to those mentioned above (for AP) to process the reservation packet along the BP. For example, in case of unresolved contention using traditional methods, we will perform Operations 2 and 3 but not operation 1 because the reservation is intended for a high-priority sub-burst to start with. Another major difference is that here, deflection routing is attempted as an additional operation (number 4) if performing Operations 2 and 3 still fails to accommodate the reservation for the entire length of Lh. More specifically, unlike in the case for AP, a control packet can be deflected to a different out_port than the one originally intended for.

Unlike other deflection schemes, here, we propose to use IP based routing table, rather than labeled switching, to determine which out ort to use for deflection at this and following nodes to increase the chance of the control packet successfully reaching the destination. In addition, if there is contention at the out_port determined by IP routing table at this or following node, the same procedure as the one outlined before for contention resolution along the BP is followed. This implies that another out_port may need to be determined for deflection. A control packet will fail at a node, because either it cannot be deflected to any out_port, or the offset time has been reduced so much that the burst will surpass the control packet before the control packet reaches the destination.

5) Transmission (and Retransmission) Along BP

As a result of such a reservation attempt, an ACK (full or partial) or NAK will be received by the ingress node. Since the offset time is Tp, such an ACK/NAK may be received by the ingress node before the ingress node needs to send a burst out (i.e., in less than Tp time). The following discusses all possible outcomes of a DDR for a given burst:

A) If a full NAK is received for the reservation on BP in less than Tp time, then

i) if a full ACK is received for the AP reservation, no further actions needed.

ii) If a full NAK or a partial NAK/ACK is received for AP, those lost high-packets priority packets is put into the next burst and retransmitted as a new burst (using DDR)

B) If a full ACK or only partial ACK/NAK is received for BP in less than Tp, then

i) if a full ACK is received for AP, the ingress node will send a maximum amount of not-yet-transmitted (or queued) loss-sensitive data (especially those that are delay sensitive but still have not violated its deadline), subject to the actual amount of reserved or ACKed bandwidth on BP which is less than Lh, along the BP.

ii) If a full NAK or a partial NAK/ACK is received for AP, a maximum amount of those lost high-priority (especially loss sensitive) data, which is the larger of the actual amount lost and the actual amount of reserved bandwidth on BP (which is no larger than Lh), is sent along BP, and the remaining portion of the lost high-priority data is put into the next burst and retransmitted as a new burst (using DDR).

C) If no ACKINAK (full or partial) is received for BP in less than Tp, then

i) If a full ACK is received for AP, the ingress node will send a maximum amount of not-yet-transmitted (or queued) loss-sensitive (and especially delay sensitive) data (subject to Lh) along the BP (same as in B (i)). These data will not be retransmitted until an ACK/NAK packet for the reservation along BP comes back to the ingress node. More specifically, if a full ACK for BP comes back to the ingress node afterwards, those transmitted along the BP are considered received. If a full NAK or a partial NAK/ACK comes back afterwards, all those lost data which still has enough delay budget is put into the next burst and retransmitted as a new burst (using DDR).

ii) If a full NAK or only a partial NAK/ACK is received for AP, all lost high-priority data NAKed (say Ln) is sent along BP, and the remaining portion of the reservation (yet-to be ACKed), which is equal to Lh−Ln is used to accommodate any lost low-priority data. More specifically, if a full ACK for BP later comes back to the ingress node, those transmitted along the BP are considered received. If a full NAK or a partial NAK/ACK comes back afterwards, all those lost data which still has enough delay budget is put into the next burst and retransmitted as a new burst (using DDR).

Although the present invention and its advantages have been described in the foregoing detailed description and illustrated in the accompanying drawings, it will be understood by those skilled in the art that the invention is not limited to the embodiment(s) disclosed but is capable of numerous rearrangements, substitutions and modifications without departing from the spirit and scope of the invention as defined by the appended claims.

What is claimed is:

1. A method for providing improved delivery probabilities for bursts, bursts with priority, and bursts containing a plurality of packets wherein each of said packets may have an assigned priority, loss sensitivity, and delay sensitivity; comprising the steps of:
at a ingress node, assembling a burst wherein the packets within said burst have the same a egress node destination,
for each pair of said ingress and said egress nodes, define a link disjoint or node disjoint pair of paths called a active path or AP, and a backup path or BP, to send said burst from said ingress node to said egress node.
at said ingress node, constructing a burst control packet containing information about said burst and sending it along said AP on a designated control channel to a second node, said second node either being a node intermediate to said egress node, or being said egress node,
processing the burst control packet at said intermediate node in order to set up a bandwidth reservation on a data signal channel along said AP from said ingress node to said egress node, or at said egress node in order to drop said burst at the burst disassembly unit,
sending said burst to said egress node along said AP on said data signal channel in a burst switched mode without requiring means of burst delay such as fiber delay lines or buffer memory, and without requiring means of signal channel conversion.

2. A method of claim 1, wherein each said packet within said burst may have a different said priority, a different said loss sensitivity, and a different said delay sensitivity.

3. A method of claim 1 where said packets with one or more lowest said priorities are assembled into low priority sub-bursts placed at either or both ends of said burst.

4. A method of claim 1 wherein a marker is placed between said low priority sub-bursts within said burst, and higher priority sub-bursts within said burst.

5. A method of claim 1 wherein zero or more said markers may be placed in-between high priority packets within said burst or high priority sub-bursts, but no markers are placed in-between said low priority packets within said burst or said low priority sub-bursts.

6. A method of claim 1 wherein said control packet will contain information on the priority of said burst.

7. A method of claim 1 wherein said control packet will contain information on the number, and if not zero, the type and location of said markers within said burst.

8. A method of claim 1 wherein said burst priority is calculated based on said priority of said packets within said burst.

9. A method of claim 1 wherein said burst priority is calculated based on a weighted sum of said packet priorities within said burst.

10. A method of claim 1 comprising the steps of:
at said ingress node, constructing a second burst control packet and sending it along said BP on a designated control channel to a second node, said second node either being a node intermediate to said egress node, or being said egress node
processing said second burst control packet at said intermediate node in order to set up a bandwidth reservation on a data signal channel along said BP from said ingress node to said egress node, or at said egress node in order to drop said burst at the burst disassembly unit,
sending said burst to said egress node along said BP on said data signal channel in a burst switched mode without requiring burst delay devices such as fiber delay lines or buffer memories, and without requiring means of signal channel conversion.

11. A method wherein contention with a bandwidth reservation along said AP at a contended node is resolved comprising the steps of:
first, by using means for signal channel conversion, such as wavelength conversion, to resolve said contention when said means are available at said contended node,
then, if said contention remains unresolved, then by using means for burst delay, such as fiber delay lines, to resolve said contention when said means are available at said contended node
then, if said contention remains unresolved, then by dropping a portion or all of said low-priority sub-bursts of said burst at said contended node.
then, if said contention remains unresolved, then by splitting said high-priority burst or said high-priority sub-bursts remaining, into multiple said high-priority sub-bursts, and schedule these multiple said high-priority sub-bursts on to other said signal channels, and create a new control packet for each of said high-priority sub-bursts, at said contended node.
then, if said contention remains unresolved, then by dropping an already-scheduled bandwidth reservation of a contenting burst or a sub-burst of said contenting burst, said contending burst or sub-burst of said contending burst having a lower priority than said burst, and sending a bandwidth reservation change packet for said already-scheduled bandwidth reservation for said contending burst at said contended node.
then, if said contention remains unresolved, then by dropping said burst and sending a full NAK back from said contended node to said ingress node, or, by dropping said high-priority sub-bursts of said burst and sending a partial NAK back from said contended node to said ingress node.

12. A method of claim 11 wherein upon receipt of said bandwidth reservation change packet, the schedule for a switch fabric controller at said contended node, and the schedule for a channel bandwidth manager at said contended node, is changed.

13. A method of claim 1 wherein said egress node sends a full ACK to said ingress node upon successfully making a reservation for said burst, or, said egress node sends a partial ACK to said ingress node upon successfully making said reservation for said sub-burst.

14. A method of claim 10 wherein said bandwidth reservation on said BP is made only for said high-priority sub-bursts within said burst, and with an offset time Tp being at least equal to the expected time for said ingress node to receive said ACK or said NAK from said egress node concerning said reservation made on said AP.

15. A method wherein contention with said bandwidth reservation along said BP for said high priority burst at a contended node is resolved comprising the steps of:
first, by using means for signal channel conversion such as wavelength conversion to resolve said contention when means are available at said contended node
then, if said contention remains unresolved, then by using means for burst delay such as fiber delay lines, to resolve said contention when said means are available at said contended node
then, if said contention remains unresolved, then by splitting said high-priority burst into multiple high priority sub-bursts, and schedule said high priority sub-bursts onto other said signal channels, and create a new said control packet for each said high-priority sub-burst.
then, if said contention remains unresolved, then by dropping an already-scheduled reservation for a second burst or a sub-burst of said second burst, said second burst or said sub-burst of said second burst having a lower priority than said burst, and sending a reservation change packet for said already-scheduled reservation for said second burst at said intermediate node
then, if said contention remains unresolved, then by means of deflection routing at said intermediate node with said high priority burst exiting said contended node along a data path that is link disjoint from said BP.
then if said contention remains unresolved, then by dropping said burst and sending a NAK back from said contended node to said ingress node, or, dropping said high-priority sub-bursts of said high priority burst and sending a partial NAK back from said contended node to said ingress node.

16. A method of claim 15 wherein upon receipt of said reservation change packet at said contended node, the schedule for a switch fabric controller at said intermediate node, and the schedule for a channel bandwidth manager at said intermediate node, is changed.

17. A method of claim 1 wherein said egress node sends said full ACK to said ingress node upon successfully making reservation for said high priority burst, or sends said partial ACK to said ingress node upon successfully making a reservation for said high priority sub-burst.

18. A method of claim 10 wherein upon receipt at said ingress node of said full NAK for said BP, and said full NAK or said partial NAK for said AP in less than said offset time Tp, then:
when said full NAK is received for said AP, the dropped high priority burst is assembled into the next burst and is retransmitted as a new said burst to said egress node along said AP,
when said partial NAK is received for said AP, the dropped high priority sub-bursts are assembled into the next burst and are retransmitted as a part of the new said burst to said egress node along said AP.

19. A method of claim 10 wherein upon receipt at said ingress node of said full ACK or a partial ACK/NAK for said BP and said full ACK for said AP in less than said offset time Tp, the said ingress node sends, according to the said offset time Tp, a maximum amount of not-yet-transmitted or queued packets at said ingress node to said egress node, with preference for said loss-sensitive packets that are delay sensitive but have not yet exceeded their delay deadline, not exceeding the actual amount of reserved as reported by said ACK for said BP along the said BP.

20. A method of claim 10 wherein upon receipt at said ingress node of said full ACK or said partial ACK/NAK for said BP, and said full NAK or said partial NAK/ACK for said AP in less than said offset time Tp, the said ingress node:
sends, according to the said offset time Tp, a maximum amount of packets, not exceeding the actual amount of bandwidth reserved as reported by said ACK for said BP, with the first preference for high-priority, loss sensitive packets that have been lost as reported by said NAK for said AP, second preference for delay sensitive packets that have been lost as reported by said NAK for said AP, but have not yet exceeded their delay deadline, third preference for not-yet-transmitted or queued high-priority packets at said ingress node for said egress node, the fourth preference for low-priority packets that have been lost as reported by said NAK for said AP, and the fifth (last) preference for not-yet-transmitted or queued low-priority packets at said ingress node for said egress node, along the said BP,
assembles any remaining portion of the lost high-priority packets reported by said full or partial NAK for said AP into the next burst and sends the said new burst along said AP.

21. A method of claim 10 wherein upon receipt at said ingress node of no said full ACK, or said full NAK or said partial ACK/NAK for said BP, and upon receipt of a said full ACK for said AP in said offset time Tp, said ingress node sends a maximum amount of not-yet-transmitted or queued loss-sensitive packets at said ingress node for said egress node, with preference for said loss-sensitive packets that are delay sensitive but have not yet exceeded their delay deadline, not exceeding the amount of bandwidth requested by said second reservation on said BP, along said BP, further comprising the step of:
when said full NAK or said partial NAK/ACK for said BP is received at said ingress node after the said offset time Tp, all lost said high-priority packets reported by said full NAK or said partial NAK for said BP which still have enough delay budget are assembled into the next burst and retransmitted by the said ingress node along said AP.

22. A method of claim 10 wherein upon receipt at said ingress node of no said full ACK, said full NAK or said partial ACK/NAK for said BP, and upon receipt of said full NAK or said partial NAK/ACK for said AP within said offset time Tp, the said ingress node sends a maximum amount of packets, not exceeding the amount of bandwidth requested by said second reservation on said BP, with the first preference for high-priority, loss sensitive packets that have been lost as reported by said NAK for said AP, second preference for delay sensitive packets that have been lost as reported by said NAK for said AP, but have not yet exceeded their delay deadline, third preference for not-yet-transmitted or queued high-priority packets at said ingress node for said egress node, the fourth preference for low-priority packets that have been lost as reported by said NAK for said AP, and the fifth (last) preference for not-yet-transmitted or queued low-priority packets at said ingress node for said egress node, along the said BP, further comprising the step of:
when a said full NAK or said partial NAK/ACK for said BP is received at said ingress node after said offset time Tp, all the lost said high-priority packets reported with the said full NAK or said partial NAK for said BP which still have enough delay budget are assembled into the next burst and retransmitted by the said ingress node along said AP.
